(19) United States
(12) Patent Application Publication
(10) Pub. No.: US 2007/0283261 A1
(43) Pub. Date: Dec. 6, 2007

(54) Gesture-Based Transient Prioritization Processes Scheduling

(76) Inventor: Christopher Harrison, Mount Kisco, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/422,468

(22) Filed: Jun. 6, 2006

(51) Int. Cl. G06F 9/00

(52) U.S. Cl. 715/700; 715/863; 715/764

(57) ABSTRACT

A method for allowing a computer user to allocate additional computing resources to a specified priority process comprises indicating with a pointing device a specified priority process by a predetermined user gesture using the pointing device. The motion of the pointing device is detected and the predetermined user gesture is associated associates with the specified priority process. Additional computing resources are removed from other background running applications and dedicated to the specified priority process.

### BACKGROUND

1. Field of the Invention

The embodiments of the invention generally relate to graphic user inputs, and, more particularly, to a method which provides the user with the ability to designate the importance or priority of a process of interest based on the users needs at a given time. In the method of the invention, a computer user allocates additional computing resources to a specified priority process by indicating the importance of a particular application so that computing resources are removed from other background running applications and those computing resources could be applied to the specified priority process.

2. Description of the Related Art

Processes scheduling has been at the forefront of operating systems research since the 1960's. The most significant advance in user-perceived performance has not come from better scheduling algorithms but rather increased processor speeds. Generally, a plurality of programs are executed concurrently in a computer, so that a plurality of executable units (i.e. run units) named as “processes” are permitted to be present therein. At that time, it is necessary to assign the central processing unit (CPU) to each process according to an algorithm. Such assignment of computing resources and CPU time to a process is referred to as “process scheduling”. Process scheduling is performed in a batch system, a time-sharing system or any other process scheduling systems, as are known in the art. Further, conventional process schedulers were created for the purpose of increasing the CPU utilization (efficiency) of the entire system. In the case of time-sharing systems, reduction in response time required to respond to a user's operation (i.e. the improvement of response performance) was further taken into account. It, however, has been regarded as being inevitable that the response time becomes long under heavy load conditions of the systems. Thus, there is no guarantee on the utilization of the CPU by user processes.

For example, U.S. Pat. No. 6,668,269, incorporated herein by reference, discloses a computer system priority process scheduler that assigns user level processes first priority. The scheduling is carried out by means of a user program by utilizing a scheduler supported by an operating system. However, the art does not provide for user designation of process priority in real time.

Real-time user applications, like windowing systems or streaming video players have posed the greatest challenge for process scheduling. Sometimes users want processes to respond immediately and complete quickly; other times, users accept latency, where processes share resources more evenly. Thus, it is exceptionally difficult for existing schedulers to determine which processes the user feels are most important and when. Therefore, there is a need for users to have the ability to allocate computing resources and CPU time to designated processes and have immediate real-time control over process scheduling.

### SUMMARY

In view of the foregoing, an embodiment of the invention provides a method for allowing a computer user to allocate additional computing resources to a specified priority process. In this method, the user indicates with a pointing device the specified priority process. A special motion of the pointing device is made by the user. The special motion of the pointing device comprises a predetermined user gesture, i.e. special motion of the pointing device, which can be associated with the specified priority process. Additional computing resources for other background running applications are removed. Those additional computing resources are then allocated to the specified priority process indicated by the user by the predetermined user gesture of the pointing device. It is, therefore, an object of the invention to provide an improved method for process scheduling whereby a user has direct real-time input as to the priority of processes and the allocation of computing resources.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a preferred method of the invention; and

FIG. 2 a schematic diagram of a computer and pointing device.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

People place different levels of importance on applications they use. This importance is often transient. For example, when the user is in a rush and wants to quickly check their email before they leave, the email applications should not have to wait on other applications. However, other times, the user might accept a longer launch time because they also value backgrounds processes, like downloading a file or transferring pictures from their digital camera.

Anticipating user needs is practically impossible. However, users provide a wealth of feedback in the form of gestures. One common user gesture is to rapidly shake a mouse back and forth when the responsiveness of an application is too slow. Other common user gestures include rapid keying, rapid clicking of a mouse, rapid tapping of a tablet, or rapid clicking or keying of other graphic user inputs such as a touch pad or roller ball, for example. The operating system (OS) could interpret this gesture as user frustration, and dedicate more resources and CPU time to the application the user is interacting with. The available resources include, but are not limited to, CPU, memory, memory bandwidth and network bandwidth. Allocation of resources can be accomplished by temporarily increasing the priority of the process.

Some applications slow down not because the application requires more resources, but because other, potentially background processes, are running at higher intensity. Thus, contention for resources typically occurs in short sporadic bursts. In response, gesture-based increases in prioritization are transient. The allocation of processing resources to the priority process fades over time, and eventually returns to its original level.

As mentioned, there remains a need for a method by which a user can indicate the priority of a particular process so that the system can allocate additional resources to the specified process. The embodiments of the invention achieve this by providing a method for allowing a computer user to allocate additional computing resources to a specified priority process by indicating, with a predetermined user gesture of a pointing device, a specified priority process to which the user wished to allocated additional computing resources. The operating system detects a predetermined motion of said pointing device and associates the predetermined user gesture with the specified priority process. The operating system then removes additional computing resources and CPU time for other background running applications and dedicates the additional computing resources and CPU time to the specified priority process.

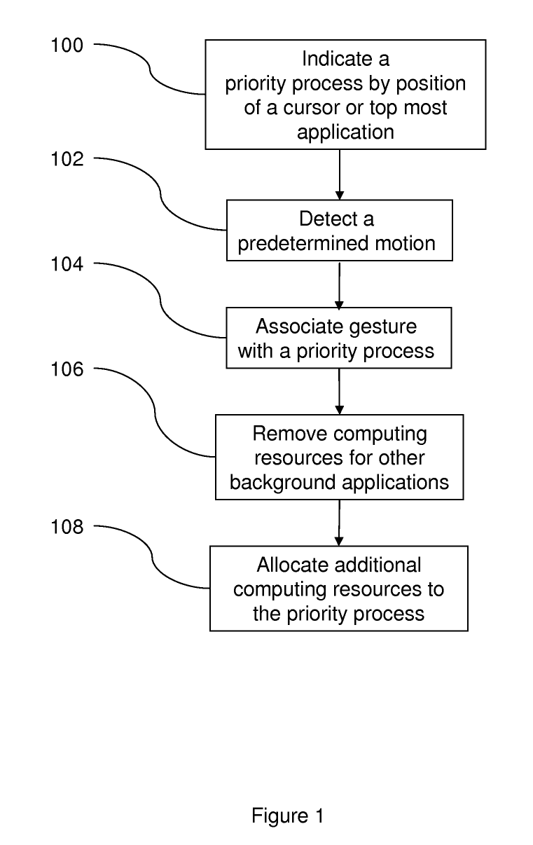

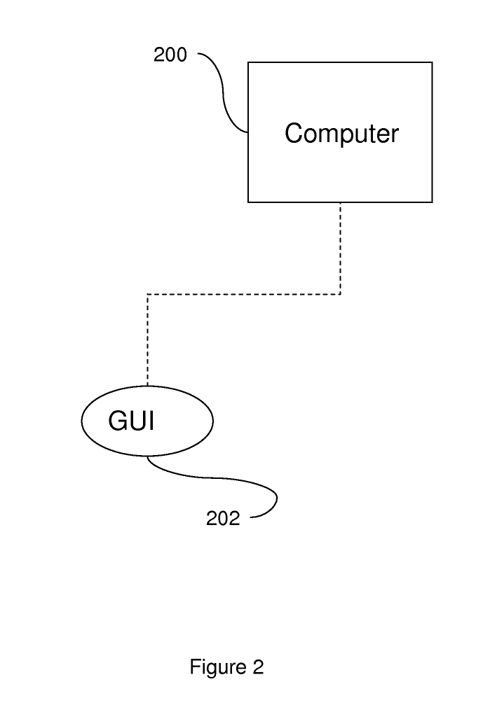

Referring now to the drawings, and more particularly to FIGS. 1 and 2, reference characters denote corresponding features consistently throughout the figures, there are shown preferred embodiments of the invention.

FIG. 1 illustrates a flow diagram according to an embodiment of the invention. FIG. 1 illustrates a method for allowing a computer user to allocate additional computing resources to a specified priority process. The user first indicates with a pointing device, or other graphic user input, a specified priority process using a predetermined user gesture of the pointing device (100). The operating system detects the predetermined user gesture made by the user with the pointing device (102). The operating system detects that the position of cursor or pointer indicates a specific application and also detects that the user wants to process an application faster when the user also inputs a predetermined user gesture into the system. In other words, the operating system detects the position of the pointer or curser and detects the predetermined user gesture. Together, these inputs detected by the system indicate the priority of the process; therefore, the operating system associates the predetermined user gesture with the specified priority process (104). In another embodiment of the invention, a user may more directly increase the priority of the topmost application, e.g., the one the user is interacting with. Moreover, the gesture can be screen wide and does not have to be over any particular window.

The operating system removes or redirects some or all computing resources from other background running applications (106) and allocates the additional computing resources to said specified priority process (108). Thus, the method can stop all other processing to devote all resources to the specified priority process. Additionally, a user can gesture again to increase the priority and may continue doing so until the responsiveness is at the desired level. For example, a first gesture results in a specified process allocation, each additional gesture by the user can increase the allocation by a predetermined factor until such a point that the system may eventually dedicate all resources to the application. Moreover, the length of time of the gesture or vigor of the gesture can indicate the value of the priority process for the allocation of resources.

In an embodiment of the present invention, the predetermined user gesture is a rapid motion of said pointing device, rapid keying, rapid clicking of a mouse, rapid tapping of a tablet, or rapid clicking or keying of other graphic user inputs such as a touch pad or roller ball, for example. The user provides information to the operating system by employing common gestures. One such gesture, for example, is the rapid shaking of a mouse back and forth or side to side. Other gestures can include rapid, repeated striking of a GUI button or keyboard key (enter key, spacebar, etc.). The use of such a gesture, when indicating a priority process (e.g. directing the on-screen pointer to a specific process on the screen), conveys the information to the operating system that the user wishes to allocate more computing resources and CPU time to the process. Thus, the execution of the process is expedited. Because a computer does not know when a process is completed, the allocation of computing resources to the priority process slowly decays overtime and becomes again available to other processes.

A representative hardware environment for practicing the embodiments of the invention is depicted in FIG. 2. This schematic drawing illustrates a hardware configuration of a computer system in accordance with the embodiments of the invention. The system minimally requires a computer (202) and includes a graphic user interface (GUI), depicted in FIG. 2 as item 202. The GUI of the invention may also include a computer mouse, a trackball, a touch pad, or pen for example.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method for allowing a computer user to allocate additional computing resources to a specified priority process comprising:
receiving a predetermined user gesture from a graphic user interface (GUI);
associating said predetermined user gesture with said specified priority process depending upon a position of a pointing device; and
allocating all computing resources to said specified priority process.

2. The method of claim 1, wherein said predetermined user gesture comprises a rapid motion of said GUI.

3. The method of claim 1, wherein said rapid motion comprises a rapid shaking of said GUI.

4. A method for allowing a computer user to allocate additional computing resources to a specified priority process comprising:
receiving a predetermined user gesture from a graphic user interface (GUI);
detecting said predetermined user gesture through said GUI;
associating said predetermined user gesture with said specified priority process depending upon a position of a pointing device;
stopping said additional computing resources for other background running applications; and
allocating all computing resources to said specified priority process.

5. The method of claim 4, wherein said predetermined user gesture comprises a rapid motion of said pointing device.

6. The method of claim 4, wherein said rapid motion comprises a rapid shaking of said pointing device.
